(19) United States
(12) Patent Application Publication
(10) Pub. No.: US 2008/0049420 A1
(43) Pub. Date: Feb. 28, 2008

(54) INVISIBLE HOLIDAY LIGHTING

(76) Inventor: Jason Paul Smith, Sartell, MN (US)

Correspondence Address: MICHAEL RIES, 318 PARKER PLACE, OSWEGO, IL, 60543, US

(21) Appl. No.: 11/843,639

(22) Filed: Aug. 22, 2007

Related U.S. Application Data
(60) Provisional application No. 60/839,889, filed on Aug. 23, 2006.

(51) Int. Cl. F21S 4/00; F21V 9/08

(52) U.S. Cl. 362/231; 362/252

(57) ABSTRACT

The present invention discloses holiday lights that will blend with the facade of a building. A concealed color matched LED tape which attaches to a roof line or around windows/doors is disclosed.

This application claims priority to U.S. provisional application No. 60/839,889 filed Aug. 23, 2006, the entire disclosure of which is herein incorporated by reference.

### TECHNICAL FIELD & BACKGROUND

The present invention generally relates to the field of holiday lights. More specifically, the present invention relates to holiday lights that will blend with the facade of a building.

A concealed color matched LED tape which attaches to a roof line or around windows/doors. The LED circuit consists many Surface Mount RGB (Red, Green, Blue) LED packages affixed to a flexible printed circuit (FPC) or flat flexible cable (FFC). The FPC or FFC is covered with a color matching top film to conceal the circuitry and LEDs for aesthetic reasons. The tape consists of 3 or more repeating circuits which allows the led to appear to scroll or dance. The LED circuits are controlled by a microcontroller based system which allows the user to select different schemes to run at different times.

The circuit and controller are described in the attached specification. There are other patents which attempt to address the same need, but this system uses an RGB LED package LEDs and utilizes pulse width modulation to mix ANY color to allow maximum flexibility and performance, also it is the only tape based one. This system also is the only self adhesive or concealed tape based product.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a drawing of a concealed color matched LED tape, in accordance with one embodiment of the present invention; and

FIG. 2 illustrates a drawing of a led controller, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising,” “having,” and “including” are synonymous, unless the context dictates otherwise.

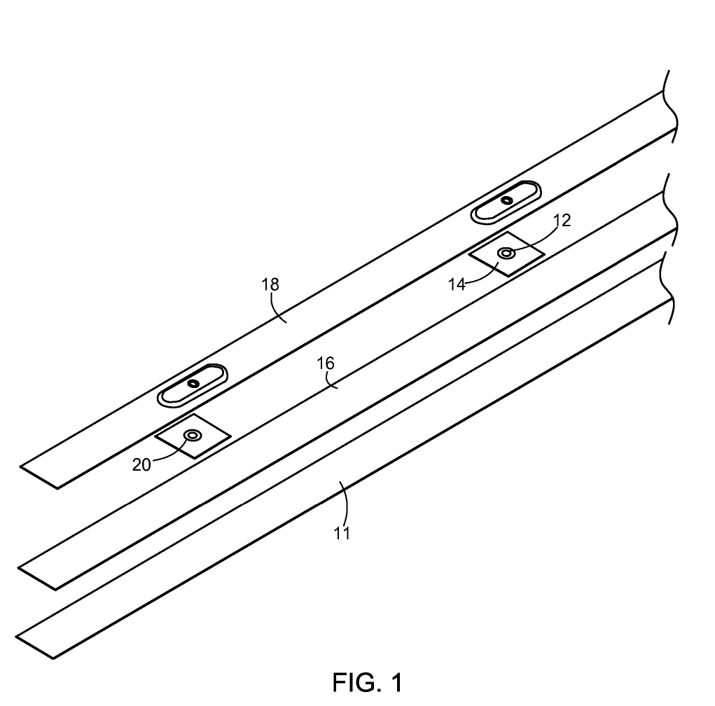

Referring now to FIG. 1, in one embodiment shown is the concealed color matched LED tape 10. The concealed color matched LED tape 10 attaches to a roof line or around windows/doors by way of adhesive backing 11. The LED circuit consists many Surface Mount RGB (Red, Green, Blue) LED packages 12 affixed to a flexible printed circuit (FPC) 14 or flat flexible cable (FFC) 16. The FPC or FFC is covered with a color matching top film or cover 18 to conceal the circuitry and LEDs 20 for aesthetic reasons. The tape consists of 3 or more repeating circuits which allows the led to appear to scroll or dance

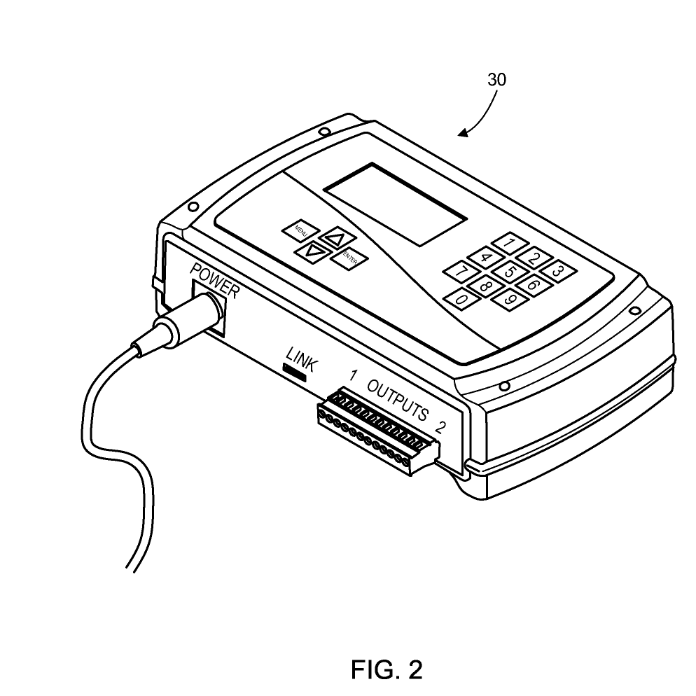

Referring to FIG. 2, as in one embodiment, a led controller 30 is provided. The controller 30 may use software or circuit design. The controller 30 is powered by an external power supply. The controller will consist of a microprocessor, membrane switch keypad, LCD module, and any other required hardware to complete the circuitry. The LEDs, which are connected to the controller via a connector, consist of 3 RGB packages per circuit.

While the present invention has been related in terms of the foregoing embodiments, those skilled in the art will recognize that the invention is not limited to the embodiments depicted. The present invention can be practiced with modification and alteration within the spirit and scope of the appended claims. Thus, the description is to be regarded as illustrative instead of restrictive on the present invention.

What is claimed is:

1. A tape of LEDs comprising:
a flexible printed circuit board;
at least one surface mounted LED affixed to the flexible printed circuit board; and
a top film that covers the flexible printed circuit board with a top film color that matches a fascia color of a building.

2. The tape of claim 1 wherein the top film allows the LED to illuminate through the tape.

3. The tape of claim 1 wherein the LEDs are red, green and blue.

4. The tape of claim 1 wherein a flat flexible cable is under the flexible printed circuit board.

5. The tape of claim 4 wherein an adhesive backing is under the flat flexible cable.

6. The tape of claim 1 wherein at least three repeating circuits make the lights appear to dance.

7. The tape of claim 1 wherein at least three repeating circuits make the lights appear to have motion.

8. The tape of claim 1 wherein a controller is connected to at least one surface mounted LED.

9. The tape of claim 1 wherein a plurality of flexible printed circuit boards are connected together to make a sting of lights.

10. A method for providing invisible holiday lights comprising:
stringing a plurality of LEDs on a building; and
covering the plurality of LEDs with a cover that is a cover color that matches a fascia color of the building.

11. A tape of LEDs comprising:
a continuous flexible circuit;
at least one surface mounted LED affixed to the continuous flexible circuit; and
a top film that covers the continuous flexible circuit with a top film color that matches a fascia color of a building.

12. The tape of claim 11 wherein a controller is connected to at least one surface mounted LED.

13. The tape of claim 11 wherein the top film allows the LED to illuminate through the tape.

14. The tape of claim 11 wherein the LEDs are red, green and blue.

15. The tape of claim 11 wherein an adhesive backing is under the continuous flexible circuit.

16. The tape of claim 11 wherein at least three repeating circuits make the lights appear to dance.

17. The tape of claim 11 wherein at least three repeating circuits make the lights appear to have motion.
